(19) United States
(12) Patent Application Publication
(10) Pub. No.: US 2026/0221649 A1
(43) Pub. Date: Jul. 30, 2026

(54) VEHICULAR ANTENNA DEVICE

(71) Applicants: YOKOWO CO., LTD., Tokyo (JP); TOYOTA JIDOSHA KABUSHIKI KAISHA, Toyota-shi, Aichi (JP)

(72) Inventors: Atsushi UBUKATA, Tomioka-Shi, Gunma (JP); Daisuke NAKAMURA, Tomioka-Shi, Gunma (JP); Minoru ARATA, Tomioka-Shi, Gunma (JP); Yuki KIKUCHI, Tomioka-Shi, Gunma (JP); Shogo KATOH, Toyota-shi, Aichi (JP); Takuma SAWAYA, Toyota-shi, Aichi (JP)

(73) Assignees: YOKOWO CO., LTD., Tokyo (JP); TOYOTA JIDOSHA KABUSHIKI KAISHA, Toyota-shi, Aichi (JP)

(21) Appl. No.: 19/148,559

(22) PCT Filed: Jan. 12, 2024
(86) PCT No.: PCT/JP2024/000604

§ 371 Date: Jul. 16, 2025

(30) Foreign Application Priority Data
Jan. 18, 2023 (JP) 2023-006073

(51) Int. Cl. H01Q 1/32; H01Q 5/307

(52) U.S. Cl. CPC H01Q 1/3275; H01Q 5/307

(57) ABSTRACT

A vehicular antenna device includes: a device portion that includes an antenna element; and a metal plate portion that holds the device portion. The metal plate portion is mounted to a metal part at a periphery of a hole or a cut-out formed in a metal roof of a vehicle, or mounted to a top surface of a roof lining of the vehicle. The device portion is positioned below a region in which the hole or the cut-out is positioned, when the metal plate portion is mounted.

### TECHNICAL FIELD

The present disclosure relates to a vehicular antenna device.

### BACKGROUND ART

A vehicular antenna device in which an antenna unit is embedded in a vehicle body has been proposed, as disclosed in Patent Literature 1.

### CITATION LIST

### Patent Literature

[PTL 1] Japanese Patent Application Publication No. 2019-071643

### SUMMARY OF INVENTION

### Technical Problem

However, some work may be conducted at places that are difficult to see, which may increase burden on a worker.

Accordingly, the present disclosure is directed to, for example, facilitating mounting or removal of a vehicular antenna device.

### Solution to Problem

A vehicular antenna device according to an aspect of the present disclosure comprises: a device portion that includes an antenna element; and a metal plate portion that holds the device portion. The metal plate portion is mounted to a metal part at a periphery of a hole or a cut-out formed in a metal roof of a vehicle, or mounted to a top surface of a roof lining of the vehicle. The device portion is positioned below a region in which the hole or the cut-out is positioned, when the metal plate portion is mounted.

### Advantageous Effects of Invention

As described above, according to the present disclosure, it is possible to facilitate mounting and removal of a vehicular antenna device.

### BRIEF DESCRIPTION OF DRAWINGS

FIG. 1 is a perspective view of a vehicular antenna device according to a first embodiment, a metal roof, and a lid portion when seen from above.

FIG. 2 is a perspective view of a vehicular antenna device according to a first embodiment when seen from above.

FIG. 3 is a perspective view of a metal roof to which a vehicular antenna device according to a first embodiment is mounted and a lid portion, when seen from above.

FIG. 4 is a perspective view of a metal roof to which a vehicular antenna device according to a first embodiment and a lid portion are mounted, when seen from below.

FIG. 5 is a cross-sectional configuration diagram of a vehicular antenna device according to a first embodiment when seen from left.

FIG. 6 is a perspective view of a metal roof to which the vehicular antenna device according to a second embodiment is mounted, and a lid portion, when seen from above.

FIG. 7 is a perspective view of a roof lining to which a vehicular antenna device according to a third embodiment is mounted, a metal roof, and a lid portion, when seen from above.

FIG. 8 is a perspective view of a metal roof to which a vehicular antenna device according to a third embodiment and a roof lining are brought close, and a lid portion, when seen from above.

FIG. 9 is a cross-sectional view of a vehicular antenna device according to a third embodiment when seen from left.

FIG. 10 is a perspective view of a lid portion to which a vehicular antenna device according to a fourth embodiment is mounted, when seen from below.

FIG. 11 is a bottom view of a lid portion to which a vehicular antenna device according to a fourth embodiment is mounted.

FIG. 12 is a cross-sectional view taken along line A-A of FIG. 11.

FIG. 13 is a cross-sectional configuration diagram of a vehicular antenna device according to a fourth embodiment when seen from left.

FIG. 14 is a perspective view of a vehicular antenna device according to a fifth embodiment, when viewed from above.

FIG. 15 is a cross-sectional view taken along line B-B of FIG. 14.

FIG. 16 is a diagram for explaining a modification example of a vehicular antenna device according to a fifth embodiment.

FIG. 17 is a diagram for explaining a state in which a vehicular antenna device according to a fifth embodiment includes an antenna element.

FIG. 18 is a perspective view of a vehicular antenna device according to a sixth embodiment when viewed from above.

FIG. 19 is a cross-sectional configuration diagram of a vehicular antenna device according to a sixth embodiment when seen from left.

### DESCRIPTION OF EMBODIMENTS

The following describes an embodiment of the present disclosure with reference to the drawings. Embodiments are not limited to following embodiments. In principle, the contents described in one embodiment are similarly applicable to other embodiments. Further, each embodiment and each modification example can be combined as appropriate. The same or equivalent components, members, and the like illustrated in the drawings are given the same reference numerals, and redundant description thereof is omitted as appropriate.

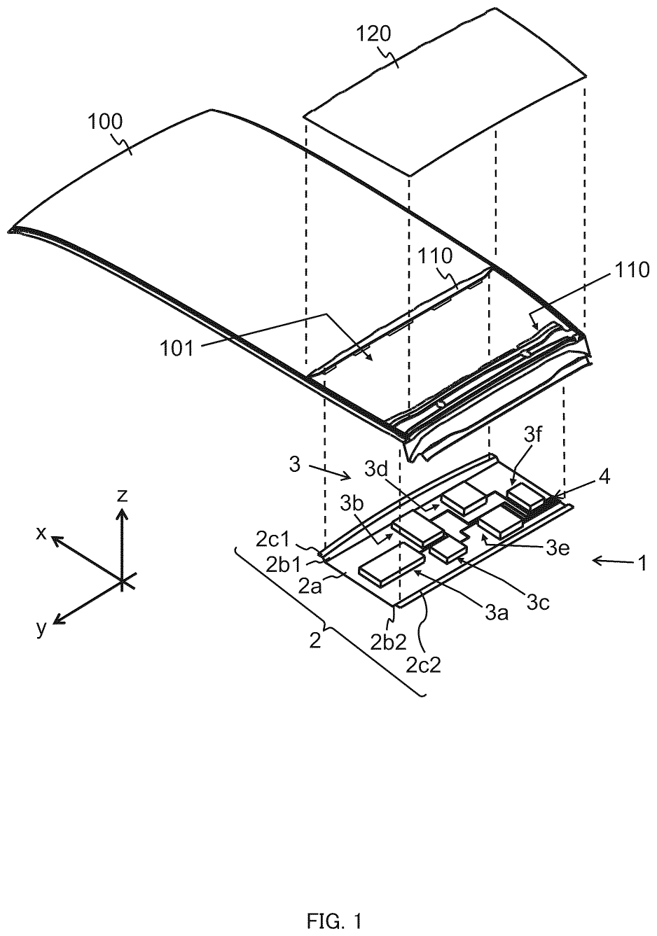

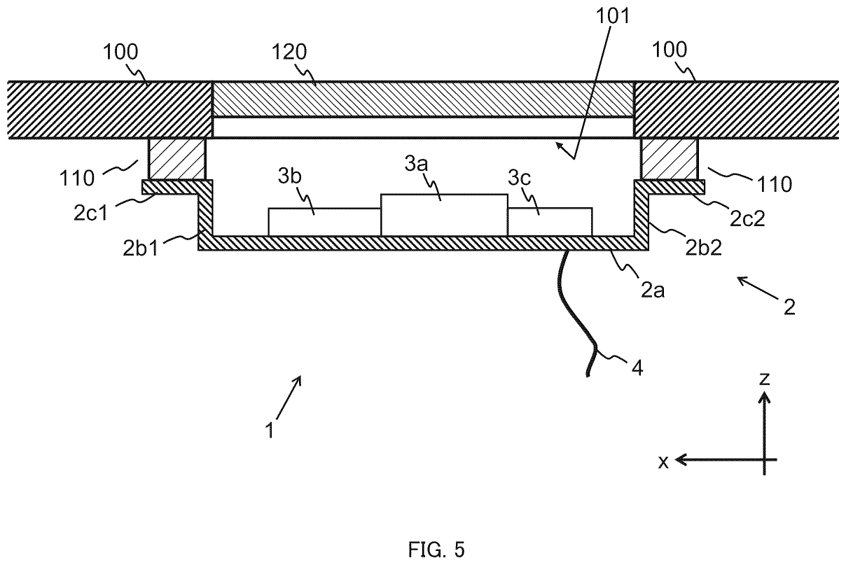

In order to describe directions, a description will be given assuming that an x direction is a front-rear direction of a vehicle to which a vehicular antenna device 1 is to be mounted, a y is direction a left-right direction perpendicular to the x direction, and a z direction is a substantially vertical direction perpendicular to the x direction and the y direction. In FIG. 1 and the like, the directions indicated by the arrows of the x-axis, y-axis, and z-axis are defined as a forward direction, a leftward direction, and an upward direction, respectively. In order to clarify the configuration of each portion, FIGS. 5, 9, and 13 illustrate a holding portion 2a and the like in a simplified shape.

(Region in which Vehicular Antenna Device 1 is to be Mounted)

The vehicular antenna device 1 of a first embodiment is mounted to a member on an upper side of a vehicle, such as a metal roof 100, as illustrated in FIG. 1. An opening 101 is formed in the region of the metal roof 100 in which the vehicular antenna device 1 is to be mounted. A metal plate portion 2 of the vehicular antenna device 1 is mounted to a metal part of the vehicle at the periphery (edge portion) of the opening 101. When the metal plate portion 2 is mounted, the metal plate portion 2 is positioned below, in the z direction, the periphery of the opening 101. The region in which the metal plate portion 2 is to be mounted may be in the metal roof 100 or a reinforcement 110 of the vehicle. In order to cover a device portion 3 (described later) from above in the z direction and close (cover) the opening 101, the lid portion (resin roof) 120 made of a material, such as resin, allowing radio waves to be transmitted therethrough is mounted at the upper side in the z direction of the periphery of the opening 101. A region of the top surface of the metal roof 100 that is to contact (region adjacent to or near) the lid portion 120, and the top surface of the lid portion 120 are configured to be positioned substantially on the same plane. That is, the top surface of the lid portion 120 has a substantially shape without a region protruding upward in the z direction relative to the top surface of the metal roof 100. The top surface of the lid portion 120 has a flat shape, thereby reducing the influence on the design such as the shape of the vehicle, for example.

### (Vehicular Antenna Device 1)

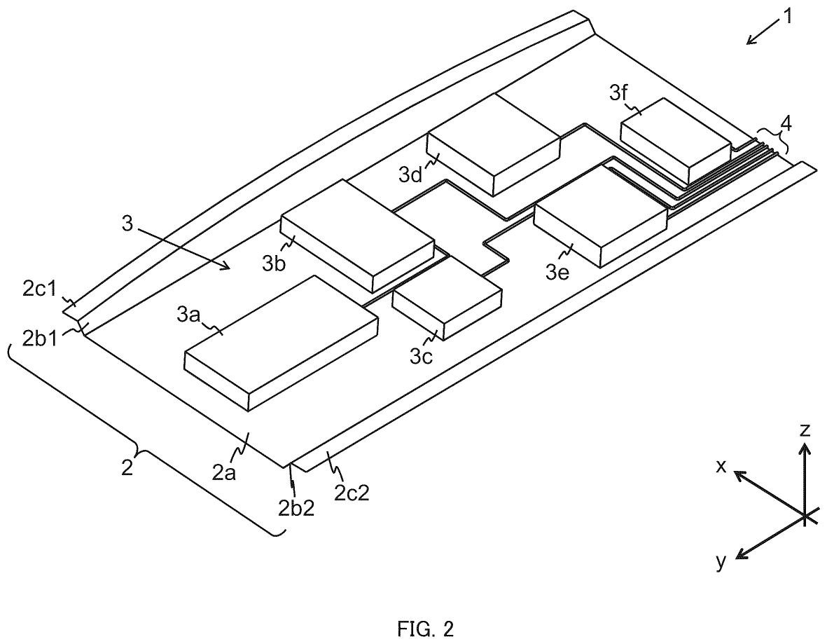

The vehicular antenna device 1 includes the metal plate portion 2, the device portion 3, a cable 4, and the lid portion 120, as illustrated in FIGS. 1 and 2.

### (Metal Plate Portion 2)

The metal plate portion 2 is made of a conductive member. The metal plate portion 2 of the first embodiment includes the holding portion 2a, a first arm portion 2b1, a second arm portion 2b2, a first connecting portion 2c1, and a second connecting portion 2c2.

The holding portion 2a is constituted by a surface that is substantially perpendicular to the z direction, and holds the device portion 3 and the cable 4. The holding portion 2a has a surface larger than that of an antenna element of the device portion 3 when viewed in the z direction. The surface forming the holding portion 2a may be flat or curved to conform to the curved shape of the metal roof 100 of the vehicle.

The first arm portion 2b1 extends upward in the z direction from a front end part in the x direction of the holding portion 2a, and is constituted by a surface that is substantially perpendicular to the x direction. The first connecting portion 2c1 extends forward in the x direction from the upper end in the z direction of the first arm portion 2b1, and is constituted by a surface that is substantially perpendicular to the z direction. The first connecting portion 2c1 is mounted to the undersurface of a metal part (in the first embodiment, the reinforcement 110 adjacent to the opening 101 at the front in the x direction) that is a front side in the x direction of the periphery of the opening 101, by a fixing means such as a screw, clip, adhesive, welding and/or the like. With the connection between the first connecting portion 2c1 and the reinforcement 110 on the front side thereof in the x direction, the metal plate portion 2 is electrically connected to the metal part of the vehicle.

The second arm portion 2b2 extends upward in the z direction from the rear end part in the x direction of the holding portion 2a, and is constituted by a surface that is substantially perpendicular to the x direction. The second connecting portion 2c2 extends rearward in the x direction from the upper end in the z direction of the second arm portion 2b2 and is constituted by a surface that is substantially perpendicular to the z direction. The second connecting portion 2c2 is mounted to the undersurface of the metal part (in the first embodiment, the reinforcement 110 adjacent to the opening 101 at the rear in the x direction) that is a rear side in the x direction of the periphery of the opening 101, by fixing means such as a screw, clip, adhesive, welding, and/or the like. With the connection between the second connecting portion 2c2 and the reinforcement 110 on the rear side thereof in the x direction, the metal plate portion 2 is electrically connected to the metal part of the vehicle.

The holding portion 2a, the first arm portion 2b1, the second arm portion 2b2, the first connecting portion 2c1, and the second connecting portion 2c2 of the metal plate portion 2 are integrally formed by bending one single metal plate.

### (Device Portion 3)

The device portion 3 includes a first device 3a, a second device 3b, a third device 3c, a fourth device 3d, a fifth device 3e, and a sixth device 3f.

### (First Device 3a)

Between a casing of the first device 3a and the holding portion 2a, electronic components such as an antenna element, a substrate, and the like are provided for the first device 3a to function as an antenna. The antenna element of the first device 3a is electrically connected to the holding portion 2a through the substrate of the first device 3a and the like. The antenna element of the first device 3a is used for telephone communications and Global Navigation Satellite System (GNSS), for example. The antenna element of the first device 3a may be used for telematics and V2X (Vehicle to X).

### (Second Device 3b, Third Device 3c)

Between a casing of the second device 3b and the holding portion 2a, electronic components such as an antenna element, a substrate, and the like are provided for the second device 3b to function as an antenna. The antenna element of the second device 3b is electrically connected to the holding portion 2a through the substrate of the second device 3b and the like. Between a casing of the third device 3c and the holding portion 2a, electronic components such as an antenna element, a substrate, and the like are provided for the third device 3c to function as an antenna. The antenna element of the third device 3c is electrically connected to the holding portion 2a through the substrate of the third device 3c and the like. The antenna elements of the second device 3b and the third device 3c are used for a Telematics Control Unit (TCU), for example.

### (Fourth Device 3d)

Between a casing of the fourth device 3d and the holding portion 2a, electronic components such as an antenna element, a substrate, and the like are provided for the fourth device 3d to function as an antenna. The antenna element of the fourth device 3d is electrically connected to the holding portion 2a through the substrate of the fourth device 3d and the like. The antenna element of the fourth device 3d is used for Digital Audio Broadcast (DAB), SXM (Sirius XM), and DTV (digital Television), for example.

### (Fifth Device 3e)

Between a casing of the fifth device 3e and the holding portion 2a, electronic components such as an antenna element, a substrate, and the like are provided for the fifth device 3e to function as an antenna. The antenna element of the fifth device 3e is electrically connected to the holding portion 2a through the substrate of the fifth device 3e and the like. The antenna element of the fifth device is used for Amplitude Modulation (AM)/Frequency Modulation (FM), for example.

### (Sixth Device 3f)

Between a casing of the sixth device 3f and the holding portion 2a, electronic components such as an antenna element, a substrate, and the like are provided for the sixth device 3f to function as an antenna. The antenna element of the sixth device 3f is electrically connected to the holding portion 2a through the substrate of the sixth device 3f and the like. The antenna element of the sixth device 3f is used for Wireless Fidelity (Wi-Fi), for example. The antenna element of the sixth device 3f may be used for Bluetooth (registered trademark).

### (Sizes of First Device 3a to Sixth Device 3f)

The first device 3a to the sixth device 3f are configured such that the height of each of the casings in the z direction is lower than the height of each of the first arm portion 2b1 and the second arm portion 2b2 in the z direction. The first device 3a to the sixth device 3f are configured so as not to protrude upward in the z direction beyond the metal roof 100. In other words, when the vehicular antenna device 1 is mounted to the vehicle, the first device 3a to the sixth device 3f are configured so as to be positioned lower in the z direction than the upper end in the region in which the opening 101 is positioned, when viewed from above in the z direction.

### (Cable 4)

Cable 4 is used for electrical connections between the first device 3a and a vehicular electronic device (e.g., ECU: Electronic Control Unit and the like), the second device 3b and the vehicular electronic device, the third device 3c and the vehicular electronic device, the fourth device 3d and the vehicular electronic device, the fifth device 3e and the vehicular electronic device, and the sixth device 3f and the vehicular electronic device. The cable 4 has one end connected to any of the first device 3a to the sixth device 3f, and the other end part connected to the vehicular electronic device from the side part of the holding portion 2a. The cable 4 may be connected directly to the vehicular electronic device, or may be connected to the vehicular electronic device through a connecting member such as another cable. The cable 4 is fixed to the holding portion 2a. The other end part of the cable 4 may be connected to the vehicular electronic device from the front part or rear part of the holding portion 2a.

Further, the cable 4 is used for electrical connection between the devices of the device portion 3 (e.g., electrical connection between the first device 3a and the second device 3b). In this case, one end part and the other end part of the cable 4 are connected to any of the first device 3a to the sixth device 3f. The cable 4 may electrically connect between the devices of the device portion 3 along the top surface in the z direction of the holding portion 2a, and may also electrically connect between the devices of the device portion 3 along the undersurface in the z direction of the holding portion 2a.

### (Mounting Procedure)

Next, the procedure of mounting the vehicular antenna device 1 to the vehicle will be described. In advance, the device portion 3 is mounted to the holding portion 2a of the metal plate portion 2, and the cable 4 is connected to the device portion 3 and fixed to the holding portion 2a. In other words, the assembly of the vehicular antenna device 1 is completed. However, the end part on the other side of the cable 4 that is to be connected to the vehicular electronic device has not yet been connected to the vehicular electronic device.

The vehicular antenna device 1 is mounted to the metal part at the periphery of the opening 101 in the metal roof 100 of the vehicle from below in the z direction. Specifically, the first connecting portion 2c1 of the metal plate portion 2 is mounted to the undersurface of the reinforcement 110 on the front side thereof in the x direction at the periphery of the opening 101, by a screw, clip, adhesive, and/or the like. In addition, the second connecting portion 2c2 of the metal plate portion 2 is mounted to the undersurface of the reinforcement 110 on the rear side in the x direction at the periphery of the opening 101, by a screw, clip, adhesive, and/or the like.

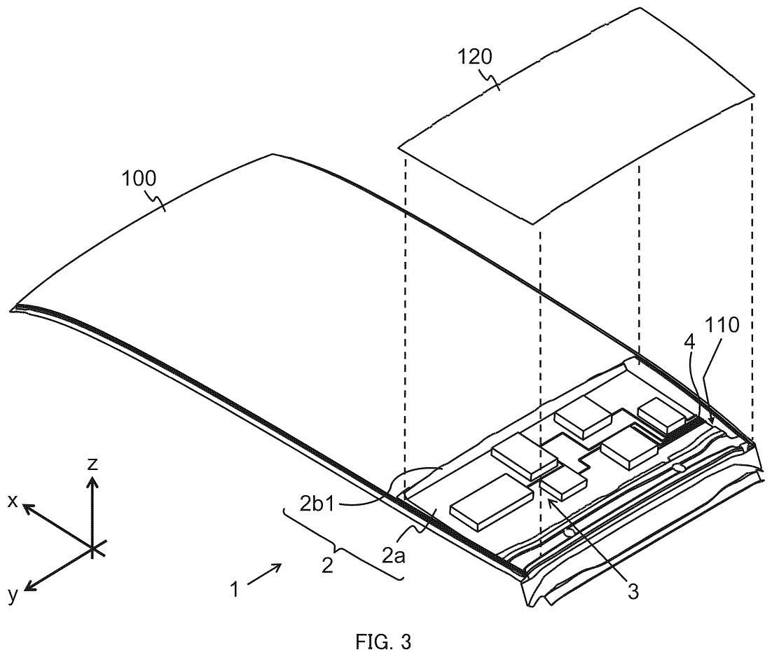

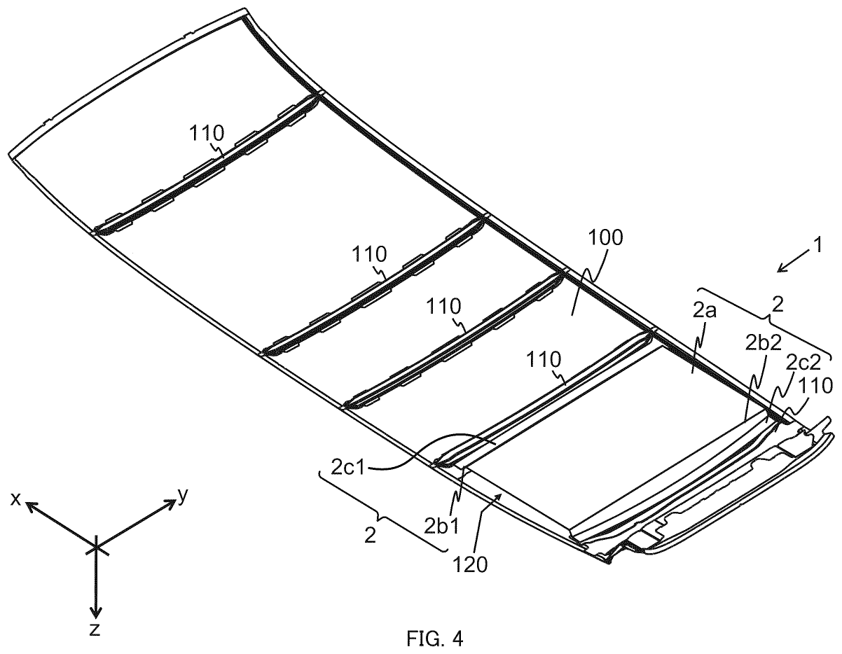

The other end part of the cable 4 that is to be connected to the vehicular electronic device is routed downward in the z direction through the gap between the side part of the holding portion 2a and the metal roof 100. FIG. 3 illustrates an example in which the end part on the other side of the cable 4 to be connected to the vehicular electronic device is routed downward in the z direction from the right in the y direction. For convenience, only some components of the metal plate portion 2 are given reference numerals in FIG. 3. As illustrated in FIGS. 4 and 5, the lid portion 120 is mounted from above in the z direction to the region in which the opening 101 is positioned in the metal roof 100. The upper part in the z direction in the region in which the opening 101 is positioned in the metal roof 100 is sealed by the lid portion 120. The lower part in the z direction in the region in which the opening 101 is positioned in the metal roof 100 is substantially closed by the metal plate portion 2. However, the space formed by the metal roof 100 and the metal plate portion 2 is open on the right side in the y direction and on the left side in the y direction.

(Effect of Device Portion 3 being Positioned Below, in z Direction, Region in which Opening 101 is Positioned, and of Metal Plate Portion 2, which Holds Device Portion 3, being Mounted to Metal Part at Periphery of Opening 101)

In the vehicular antenna device 1, the device portion 3 can be arranged, on the upper side in the z direction, in a region (on the inner side of the opening 101) in which a member blocking radio waves is not provided. In the vehicular antenna device 1, the device portion 3 and the metal part of the vehicle are electrically connected through the metal plate portion 2, thereby being able to use the metal plate portion 2 as a ground plate. The metal plate portion 2 is positioned between the vehicular electronic device and the device portion 3, thereby being able to use it also as a noise shielding plate for noise from the vehicular electronic device to the device portion 3, and a noise shielding plate for noise from the device portion 3 to the vehicular electronic device.

The vehicular antenna device 1 is mounted to the metal part of the vehicle (metal roof 100 or reinforcement 110) from below in the z direction. Thus, when a worker mounts the vehicular antenna device 1 to the vehicle, it is possible to reduce the burden on the worker, for example, reduce the amount of work at places that are difficult to see, as compared to a configuration in which the vehicular antenna device 1 is mounted to the metal roof 100 from above in the z direction or embedded in a vehicle body.

(Effect of Holding Portion 2a of Metal Plate Portion 2 Having Surface Area Larger than that of Device Portion 3)

The vehicular antenna device 1 is mounted below the opening 101 that is formed in the metal roof 100, and thus the metal plate portion 2, which functions as a ground plate, can be easily formed larger as compared with that in a configuration in which the vehicular antenna device 1 is mounted to other places. Particularly, in the metal plate portion 2, the length of the holding portion 2a can be extended to a length substantially equal to the width (length in the y direction) of the metal roof 100. Thus, in the vehicular antenna device 1, it is possible to easily configure an antenna element (e.g., an antenna for AM/FM) that needs a ground plate sufficiently larger than that of other antenna elements, at a position lower than the metal roof 100.

(Effect of Locating Metal Roof 100 and Lid Portion 120 being Positioned on the Same Plane)

The vehicular antenna device 1 can protect the device portion 3 that includes an antenna element by virtue of the lid portion 120, without causing the region where the device portion 3 including the antenna element and the like are positioned to stand out from the outside of the vehicle.

### (Application Example of Opening 101)

The first embodiment describes an example in which the device portion 3 is provided below, in the z direction, the region in which the hole (opening 101) is formed in the metal roof 100. However, the device portion 3 may be provided below, in the z direction, the upper end of the region in which a cut-out is formed in the metal roof 100, instead of the hole. In this case, the lid portion 120 is mounted to the periphery (edge) of the cut-out of the metal roof 100.

### (Application Example of Connection Place of Metal Plate Portion 2)

The first embodiment describes an example in which the first connection portion 2c1 and the second connection portion 2c2 of the metal plate portion 2 are mounted to the undersurface of the metal part (reinforcement 110) of the vehicle. However, the first connection portion 2c1 and the second connection portion 2c2 of the metal plate portion 2 may be mounted to the side surface or top surface of the metal part of the vehicle.

### (Application Example of Shape of Lid Portion 120)

The first embodiment describes an example in which the top surface of the lid portion 120 has a substantially flat shape. However, the top surface of the lid portion 120 may include a region protruding upward in the z direction. For example, the top surface of the lid portion 120 may include a region protruding upward in the z direction in a shape of a shark fin antenna.

### Second Embodiment, Application Example of Metal Plate Portion 2

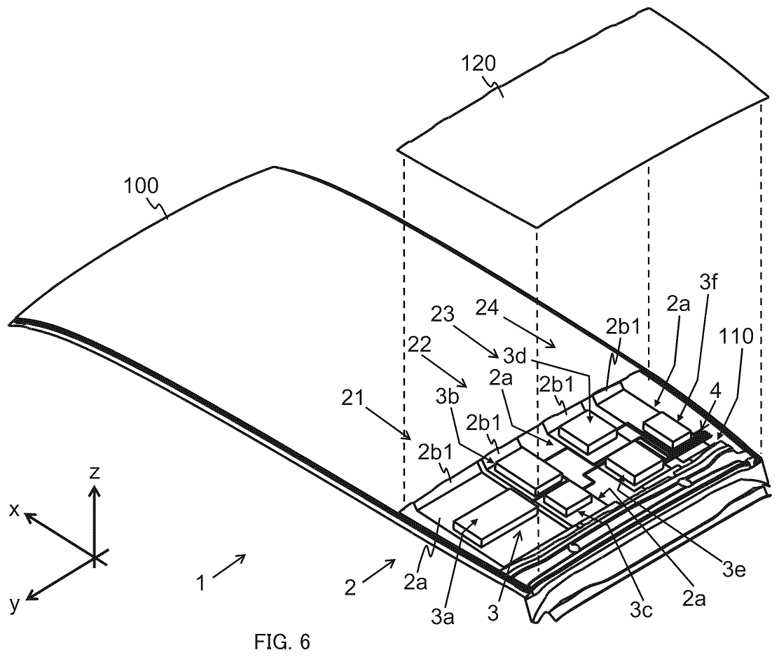

The first embodiment describes an example in which one metal plate portion 2 holds all of the multiple devices (first device 3a to sixth device 3f) that constitute the device portion 3. However, multiple plates may constitute the metal plate portion 2, and the multiple plates may hold multiple devices that constitute the device portion 3 (see FIG. 6). In this case, each of the multiple plates (first plate 21 to fourth plate 24) holds at least one of the multiple devices (first device 3a to sixth device 3f).

FIG. 6 illustrates an example in which the metal plate portion 2 includes four metal plates (first plate 21, second plate 22, third plate 23, fourth plate 24), the holding portion 2a of the first plate 21 holds the first device 3a, the holding portion 2a of the second plate 22 holds the second device 3b and the third device 3c, the holding portion 2a of the third plate 23 holds the fourth device 3d and the fifth device 3e, and the holding portion 2a of the fourth plate 24 holds the sixth device 3f. However, the number of plates constituting the metal plate portion 2 is not limited to four.

(Effect of Constituting Metal Plate Portion 2 with Multiple Plates)

A worker can mount and remove the vehicular antenna device 1 to and from the vehicle with respect to the multiple plates, individually. Thus, as compared to the first embodiment in which the metal plate portion 2 is constituted by one single large plate, it is possible to improve the workability of mounting and removal. For example, if a malfunction occurs only in the first device 3a illustrated in FIG. 6, the worker only needs to remove the first plate 21 that holds the first device 3a and replace the first device 3a. In this case, as compared to the first embodiment in which the entire metal plate portion 2 needs to be removed, it is possible to improve the workability of removing and mounting the vehicular antenna device 1 from and to the vehicle.

### Third Embodiment, Application Example of Location in which Metal Plate Portion 2 is to be Mounted

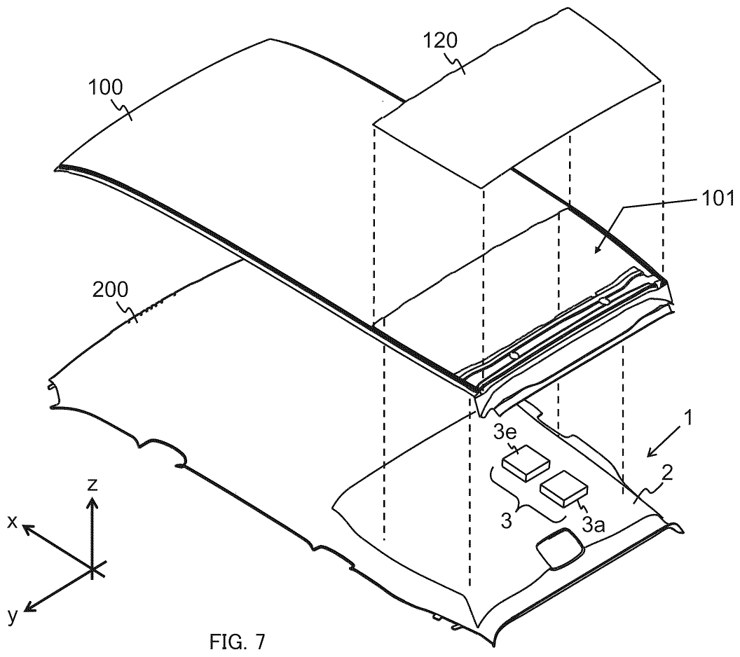

The first and second embodiments describe examples in which the metal plate portion 2 is attached to the metal part at the periphery of the opening 101 of the metal roof 100. However, the metal plate portion 2 may also be mounted to a roof lining 200 of the vehicle (see FIGS. 7 to 9).

A third embodiment illustrates an example in which the device portion 3 includes two devices (first device 3a and fifth device 3e), as illustrated in FIGS. 7 to 9. However, the device portion 3 may include three or more devices, or may include a device other than the above such as the second device 3b or the like, instead of the first device or the fifth device 3e.

The metal plate portion 2 of the third embodiment is constituted by a holding portion 2a in the form of a thin plate or foil. The holding portion 2a of the third embodiment is attached to the top surface of the roof lining 200. The holding portion 2a has an uneven shape that conforms to the shape of the region to which the holding portion 2a is attached in the roof lining 200. The roof lining 200 is made of nonwoven fabric or the like and is mounted to the undersurface of the metal roof 100. The metal plate portion 2 and the roof lining 200 may be integrally configured. The holding portion 2a of the metal plate portion 2 is configured so as to partially overlap the opening 101 when seen in the z direction. The holding portion 2a of the metal plate portion 2 is configured so as to be larger than the antenna element of the device portion 3 when seen from the z direction. Further, it is desirable that the holding portion 2a of the metal plate portion 2 is configured so as to be larger than the opening 101 when seen in the z direction.

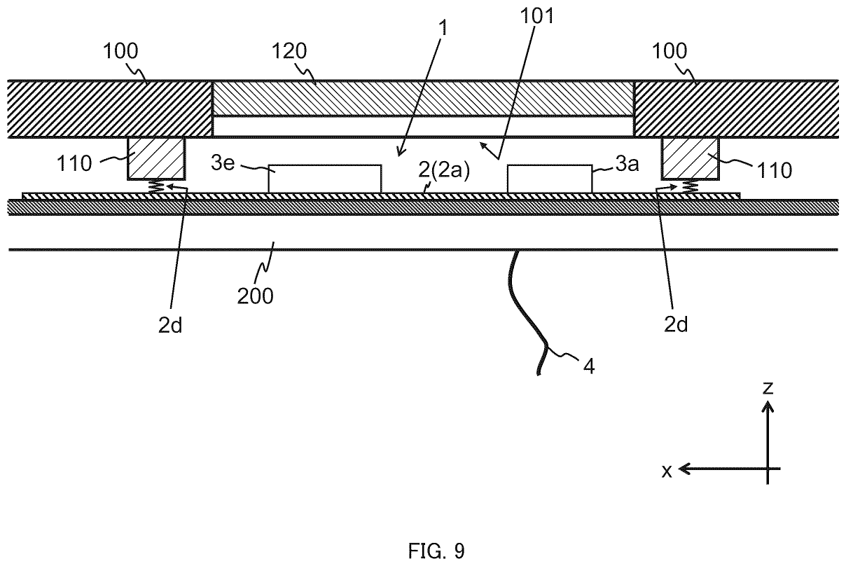

The metal plate portion 2 of the third embodiment is electrically connected to the metal part (e.g., reinforcement 110) of the vehicle through a connection method such as a spring contact, welding, or screw fastening. FIG. 9 illustrates an example in which, when the roof lining 200 is mounted to the metal roof 100, the holding portion 2a of the metal plate portion 2 is electrically connected to the reinforcement 110 of the vehicle through a metal spring 2d.

However, when the antenna element(s) of the device(s) (either or both of the first device 3a and the fifth device 3e) constituting the device portion 3 is/are used mainly for telephone communications, the metal plate portion 2 and the metal part of the vehicle do not have to be electrically connected.

The device portion 3 is mounted to the top surface of the holding portion 2a as in the first embodiment. The devices (first device 3a, fifth device 3e) constituting the device portion 3 are mounted to the holding portion 2a using a screw, clip, adhesives, and/or the like. The devices (first device 3a, fifth device 3e) that constitute the device portion 3 are configured so as to be positioned below, in the z direction, the region in which the opening 101 is positioned, seen from above in the z direction, when the vehicular antenna device 1 is mounted to the vehicle.

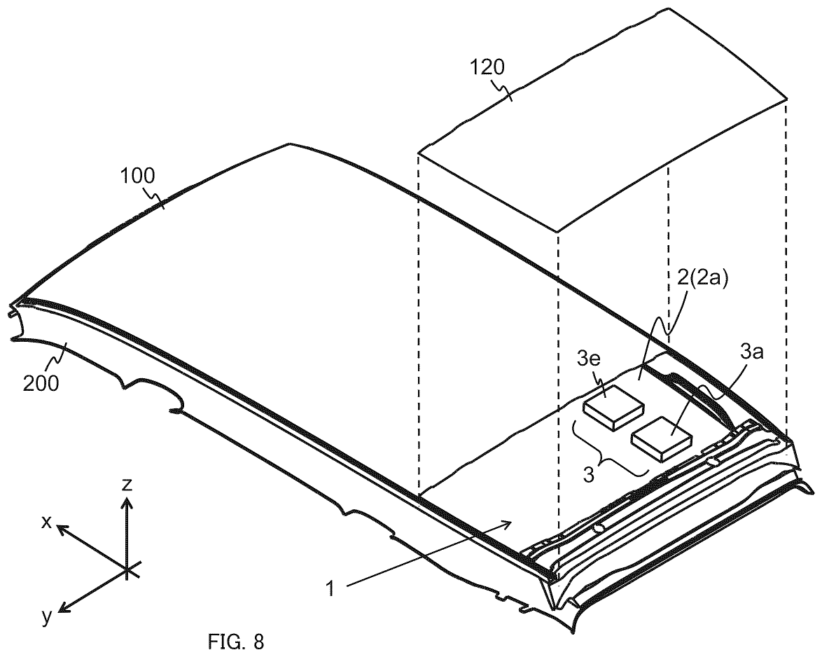

The cable 4 is used for electrical connection between the first device 3a and the vehicular electronic device, and between the fifth device 3e and the vehicular electronic device. The cable 4 has one end part connected to either one of the first device 3a or the fifth device 3e, and the other end part connected to the vehicular electronic device from the side part of the holding portion 2a. The cable 4 may be connected directly to the vehicular electronic device, or may be connected to the vehicular electronic device through a connecting member such as another cable. The cable 4 is fixed to the holding portion 2a. The other end part of the cable 4 may be connected to the vehicular electronic device from the front part or rear part of the holding portion 2a. The cable 4 may also be used for electrical connection between the devices of the device portion 3 (e.g., electrical connection between the first device 3a and the fifth device 3e). In this case, the one end part and the other end part of the cable 4 are connected to either one of the first device 3a or the fifth device 3e. The cable 4 may electrically connect between the devices of the device portion 3 along the top surface in the z direction of the holding portion 2a, and may also electrically connect between the devices of the device portion 3 along the undersurface in the z direction of the holding portion 2a. In FIGS. 7 and 8, illustration of the cable 4 is omitted.

### (Effect of Mounting Metal Plate Portion 2 to Roof Lining 200)

In the vehicular antenna device 1, the metal plate portion 2 having a large area can be provided on the roof lining 200. In particular, the holding portion 2a of the metal plate portion 2 can be extended to a length substantially equal to the width (length in the y direction) of the metal roof 100, and further, the holding portion 2a of the metal plate portion 2 can be extended in the longitudinal direction (x direction) up to the length in the x direction of the roof lining 200. Thus, as compared to the first and second embodiments in which the metal plate portion 2 is mounted to the periphery of the opening 101 of the metal roof 100, it is possible to use the metal plate portion 2 having a larger area in the third embodiment. With the use of the metal plate portion 2 having a large area, it is possible to obtain good antenna characteristics, and when multiple devices are arranged at the metal plate portion 2, increase each distance between the devices, to thereby reduce mutual electrical interference.

Since the metal plate portion 2 is in the form of a thin plate or foil, it is possible to reduce the weight of the parts mounted to the vehicle, as compared to a configuration in which the metal plate portion 2 is made of a plate having a normal thickness.

Since the vehicular antenna device 1 is mounted to the roof lining 200, a worker can mount the vehicular antenna device 1 to the vehicle in a process (such as a sub-line) that is off the main line of a vehicle factory. Thus, the worker can mount the vehicular antenna device 1 to the vehicle without increasing the load on the main line of the vehicle factory.

### Fourth Embodiment, Application Example of Location in which Vehicular Antenna Device 1 is Mounted

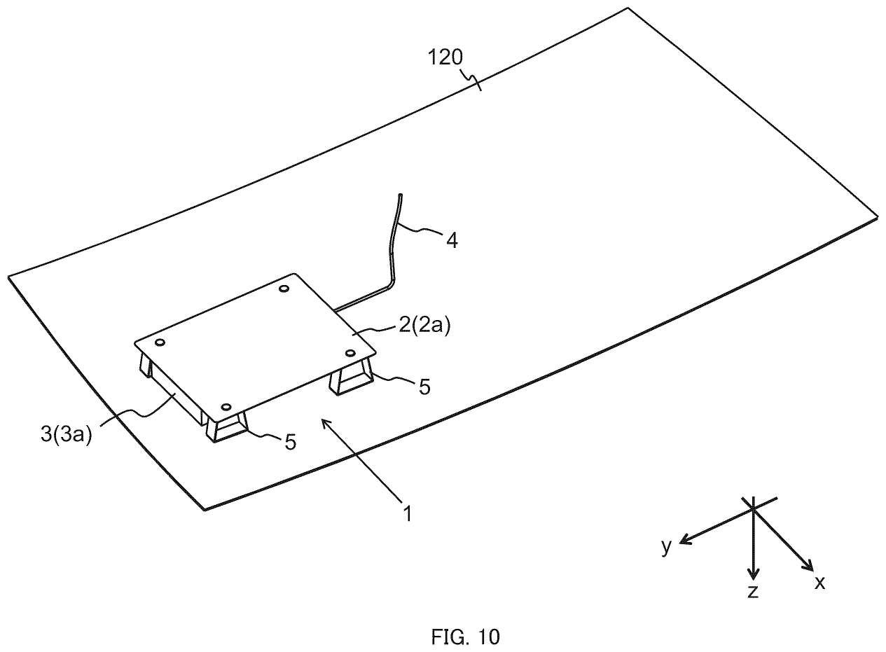

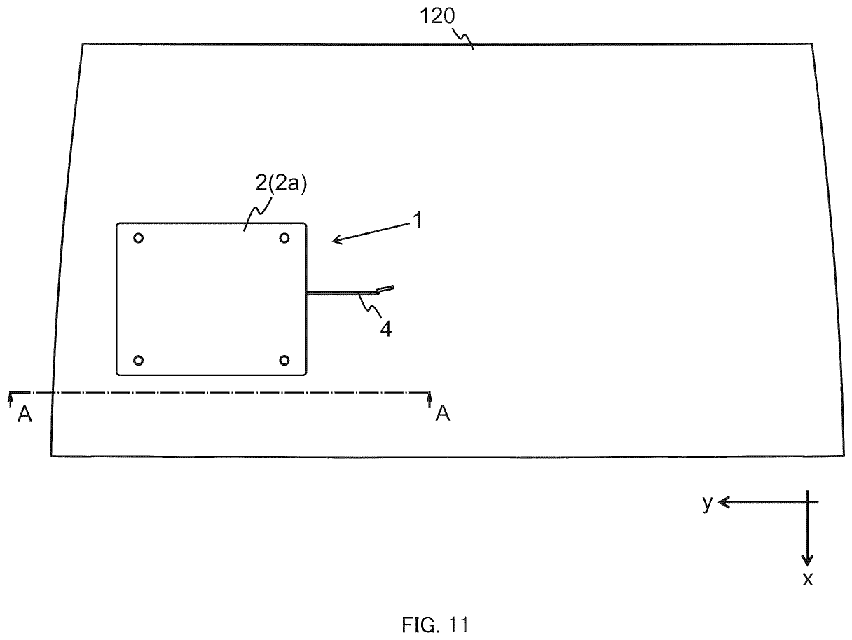

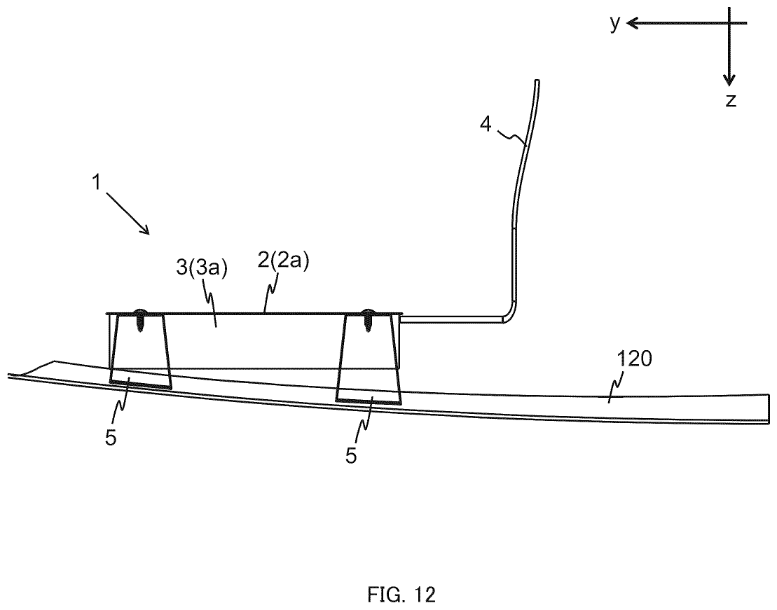

The first and second embodiments describe an example in which the device (such as first device 3a) constituting the device portion 3 is mounted to a metal part (reinforcement 110, etc.) of the vehicle through the metal plate portion 2. The third embodiment describes an example in which the device constituting the device portion 3 is mounted to the roof lining 200 through the metal plate portion 2. However, the device constituting the device portion 3 may be mounted to the lid portion 120 through the metal plate portion 2 and brackets 5 (see FIGS. 10 to 13). In the third embodiment, the antenna elements of the devices constituting the device portion 3 can be applied to all of the antennas including the antenna used for telephone communications.

A fourth embodiment illustrates an example in which the device portion 3 includes one single device (first device 3a), but the device portion 3 may include two or more devices, or the device portion 3 may include a device other than the above, such as the second device 2b or the like, instead of the first device 3a.

The metal plate portion 2 in the fourth embodiment is constituted by the holding portion 2a in a plate shape. The holding portion 2a in the fourth embodiment is mounted to the lid portion 120 through the brackets 5. The device (first device 3a) constituting the device portion 3 is mounted to the top surface of the holding portion 2a as in the first embodiment. The cable 4 is used for electrical connection between the first device 3a and the vehicular electronic device. The cable 4 has one end part connected to the first device 3a, and the other end part connected to the vehicular electronic device. The cable 4 may be connected directly to the vehicular electronic device, or may be connected to the vehicular electronic device through a connecting member such as another cable.

### (Brackets 5)

The brackets 5 are provided between the holding portion 2a and the lid portion 120. The brackets 5 are made of a non-conductive material, such as resin. The brackets 5 each include a leg forming a frame having a substantially trapezoidal shape in y-z cross section, for example. The lower end part in the z direction of the bracket 5 is mounted to each of the four corners of the holding portion 2a by a screw, clip, adhesive, or the like. Further, the upper end part in the z direction of the bracket 5 is mounted to the underside of the lid portion 120 by an adhesive and/or the like. The bracket 5 may be integrally configured with the lid portion 120. Further, the metal plate portion 2 may be mounted to the lid portion 120 without using the bracket 5. It is assumed that the bracket 5 is made of a non-conductive material, however, it may be made of a conductive material as long as the performance of the device and the like is not affected.

### (Effect of Mounting Vehicular Antenna Device 1 to the Lid Portion 120)

Since the vehicular antenna device 1 is mounted to the undersurface of the lid portion 120, the vehicular antenna device 1 can be mounted in a process (such as a sub-line) that is off the main line of the vehicle factory. Thus, the vehicular antenna device 1 can be mounted to the vehicle without increasing the load on the main line of the vehicle factory. The metal plate portion 2 and the device portion 3 are mounted to the lid portion 120 of the vehicle through the brackets 5. Thus, as compared to the configuration in which the metal plate portion 2 and the device portion 3 are mounted to the metal roof 100 or the like of the vehicle, the metal plate portion 2 and the device portion 3 can be easily mounted to and removed from the vehicle.

### (Fifth Embodiment, Modification Example of Metal Plate Portion 2 (First Embodiment))

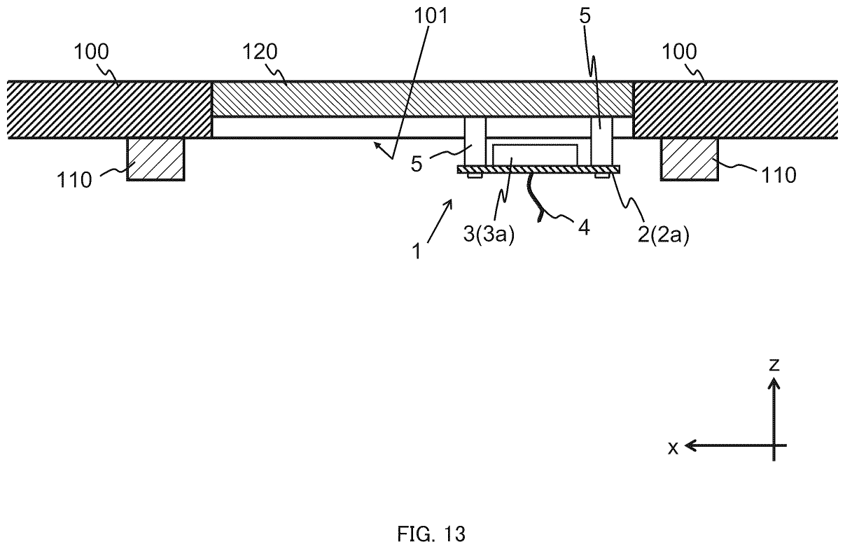

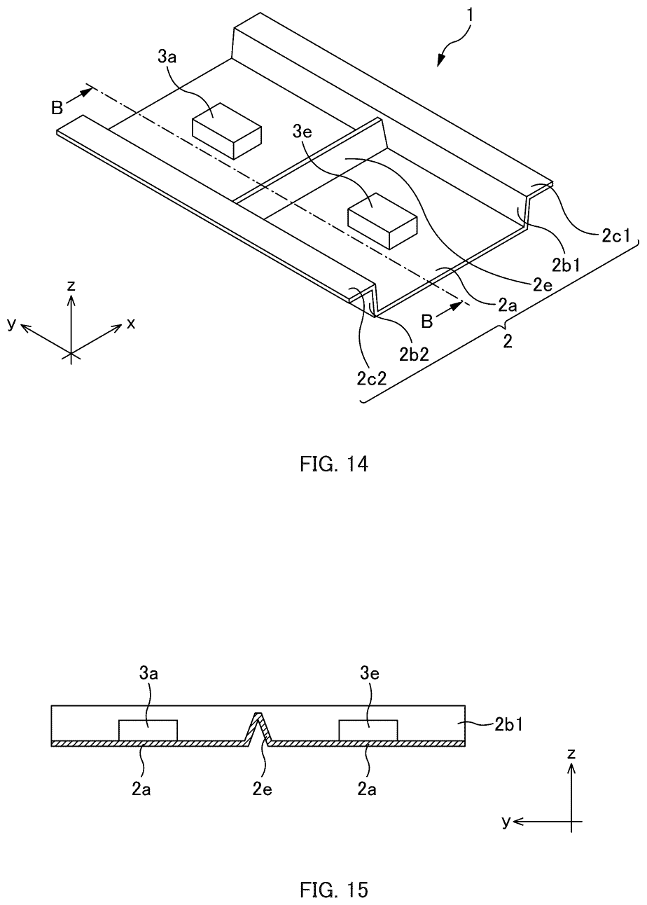

The first embodiment describes an example in which the holding portion 2a of the metal plate portion 2 holds the device portion 3 and the cable 4. However, the holding portion 2a may include a wall portion (described later) having a shape protruding upward on the top surface of the holding portion 2a (see FIGS. 14 to 17).

The fifth embodiment illustrates an example in which the device portion 3 includes two devices (first device 3a, fifth device 3e). However, the device portion 3 may include three or more devices, or may include a device other than the above such as the second device 3b or the like, instead of the first device or the fifth device 3e.

The holding portion 2a in the fifth embodiment is constituted by a surface substantially perpendicular to the z direction, and includes a wall portion 2e extending upward in the z direction near substantially the center in the y direction. The wall portion 2e is positioned between the first device 3a and the fifth device 3e, and is a portion having a shape protruding upward in the z direction from the top surface of the holding portion 2a. The wall portion 2e is formed by bending a part of the holding portion 2a upward.

In FIG. 14, the wall portion 2e has a length in the x direction from the first arm portion 2b1 to the second arm portion 2b2, but it is not limited thereto. For example, the length in the x direction of the wall portion 2e may be shorter than the length in the x direction from the first arm portion 2b1 to the second arm portion 2b2, and there may be a gap between each of the first arm portion 2b1 and the second arm portion 2b2 and the wall portion 2e. In addition, in FIG. 14, the height in the z direction of the wall portion 2e is higher than the height in the z direction of each of the first device 3a and the fifth device 3e, however it is not limited thereto. For example, the height in the z direction of the wall portion 2e may be equal to or slightly lower than the height in the z direction of each of the first device 3a and the fifth device 3e.

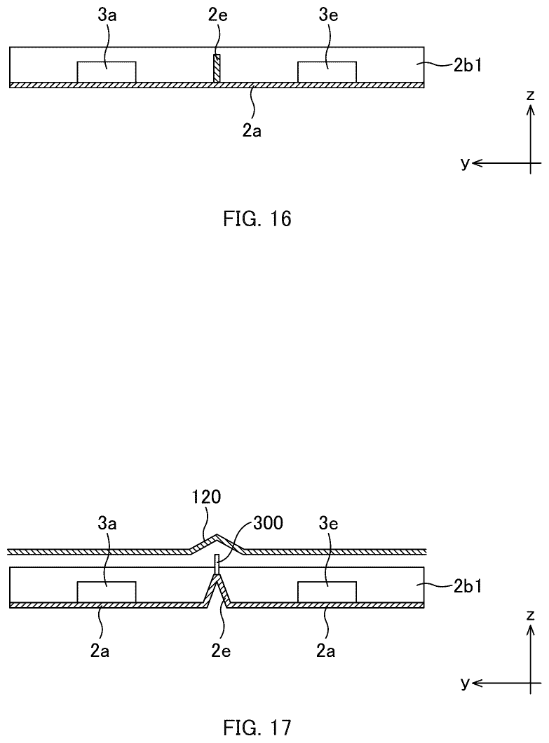

Further, the wall portion 2e in the fifth embodiment is formed by bending a part of the holding portion 2a, but it is not limited thereto. For example, a conductive member having the same shape as that of the wall portion 2e may be mounted to the top surface of the holding portion 2a by welding or the like. Further, the shape of the wall portion 2e is not limited to the shape in FIGS. 14 and 15. For example, as illustrated in FIG. 16, a conductive flat plate-shaped member may be mounted to the top surface of the holding portion 2a by welding or the like, and used as the wall portion 2e.

Further, in the fifth embodiment, for example, as illustrated in FIG. 17, the antenna element 300 used for ground waves, such as telematics, V2X, and the like, may be arranged at the top surface of the wall portion 2e. In such a case, the antenna element 300 is to be placed at a higher position in the z direction relative to the ground, in the vehicle, thereby achieving good communication. In the case illustrated in FIG. 17, the top surface of the lid portion 120 includes the region protruding upward in the z direction relative to the top surface of the metal roof 100. This makes it possible to prevent the antenna element 300 from contacting the lid portion 120.

### (Effect of Holding Portion 2a Having Wall Portion 2e)

In the fifth embodiment, the conductive wall portion 2e of the holding portion 2a is positioned between the first device 3a and the fifth device 3e. Thus, the wall portion 2e can suppress the transmission of noise from the first device 3a to the fifth device 3e, and the transmission of noise from the fifth device 3e to the first device 3a (i.e., the propagation of noise between the two devices). In other words, the wall portion 2e functions as a so-called noise shielding plate.

As such, the wall portion 2e is positioned between the first device 3a and the fifth device 3e so as to suppress the propagation of noise between the two devices. Further, the shape and location of the wall portion 2e can be appropriately changed in accordance with the characteristics of the first device 3a and the fifth device 3e.

Further, in the fifth embodiment, the wall portion 2e is positioned between the first device 3a and the fifth device 3e in the y direction. However, for example, when the first device 3a and the fifth device 3e are arranged apart from each other in the x direction, the wall portion 2e may be positioned between the first device 3a and the fifth device 3e in the x direction such that noise can be suppressed. Further, the fifth embodiment has been described using the first device 3a and the fifth device 3e as examples, but it is not limited thereto, and any one device of the device portion 3 and, for example, a common communication module (Data Communication Module (DCM)) may be used. Even in such a case, the propagation of noise between the communication module and the device can be suppressed.

### (Sixth Embodiment, Modification Example of Metal Plate Portion 2 (Fourth Embodiment))

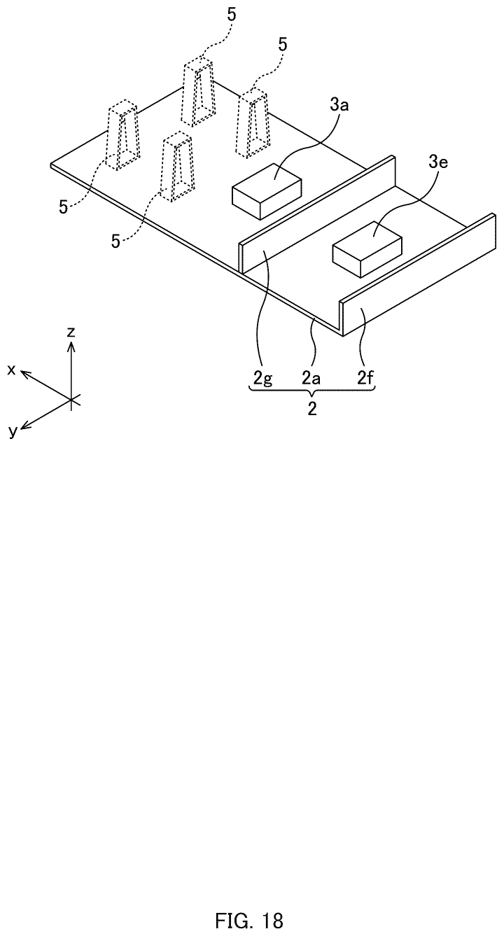

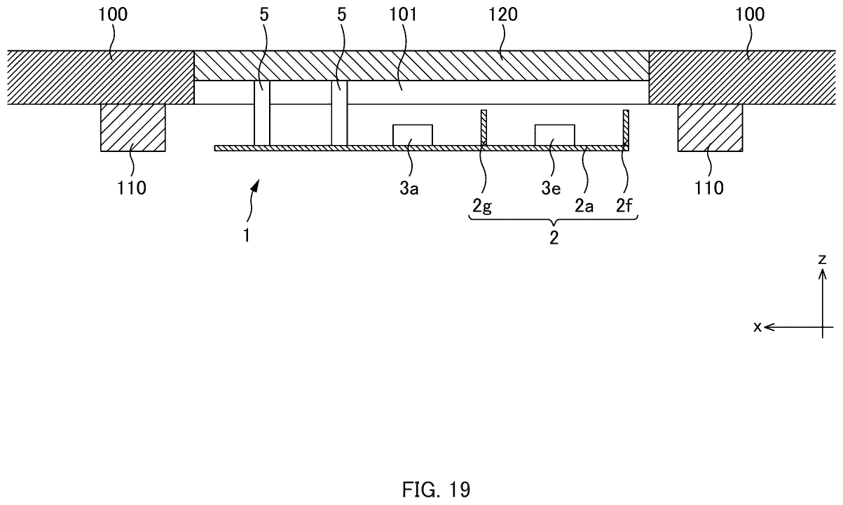

The fourth embodiment describes an example in which the holding portion 2a of the metal plate portion 2 is mounted to the lid portion 120 through the brackets 5. The sixth embodiment describes a configuration in which the holding portion 2a in a plate shape includes wall portions 2f and 2g, with reference to FIGS. 18 and 19. Further, since the cable 4, the brackets 5, and the like are the same as those in the fourth embodiment, the following describes focusing on the holding portion 2a and the wall portions 2f and 2g.

The sixth embodiment illustrates an example in which the device portion 3 includes two devices (first device 3a and fifth device 3e). However, the device portion 3 may include three or more devices, or include a device other than the above, such as the second device 3b, a communication module, or the like, instead of the first device with 3a or the fifth device 3e.

The metal plate portion 2 of the sixth embodiment includes the holding portion 2a in a plate shape and the wall portions 2f and 2g. The holding portion 2a of the sixth embodiment is also mounted to the lid portion 120 through the brackets 5 as in the fourth embodiment. However, the holding portion 2a of the sixth embodiment has an area larger than that of the holding portion 2a of the fourth embodiment.

The holding portion 2a of the sixth embodiment includes the wall portion 2f extending upward in the z direction at the rear end part in the x direction of the top surface thereof substantially perpendicular to the z direction. The wall portion 2f is formed by bending a part of the holding portion 2a upward. For example, a conductive flat plate-shaped member may be mounted to the rear end part in the x direction of the holding portion 2a by welding or the like, to thereby form the wall portion 2f.

In addition, the holding portion 2a of the sixth embodiment includes the wall portion 2g extending upward in the z direction between the first device 3a and the fifth device 3e on the top surface of the holding portion 2a. The wall portion 2g is a conductive flat plate-shaped member and is mounted to the top surface of the holding portion 2a by welding or the like. The length in the y direction of each of the wall portions 2f and 2g is equal to the width (length in the y direction) of the holding portion 2a, but it is not limited thereto.

Further, for example, as described in FIGS. 14 and 15, a part of the holding portion 2a may be processed to form the wall portion 2g, as with the wall portion 2e. In the sixth embodiment, the height in the z direction of each of the walls 2f and 2g is greater than the height in the z direction of each of the first device 3a and the fifth device 3e.

### (Effect of Holding Portion 2a Having Wall Portions 2f and 2g)

In the sixth embodiment, the wall portion 2f is formed at the rear end part in the x direction of the holding portion 2a. Thus, the wall portion 2f can suppress the propagation of noise between the fifth device 3e and a device (not illustrated) positioned rearward in the x direction, for example.

Further, the wall portion 2g extending upward in the z direction is positioned between the first device 3a and the fifth device 3e, and thus, it is possible to suppress the propagation of noise between the first device 3a and the fifth device 3e, for example.

As such, the wall portions 2f and 2g can suppress the propagation of noise between the two devices, and function as a so-called noise shielding plate. However, as long as the wall portions 2f and 2g are able to suppress the propagation of noise between the two devices, the shapes and locations of the wall portions 2f and 2g can be changed as appropriate in accordance with the characteristics of the targeted two devices. The sixth embodiment is described using the first device 3a and the fifth device 3e as examples. However, it is not limited thereto, and the similar effect can be obtained with any one device of the device portion 3 and, for example, a common communication module. Further, a description has been given of an example in which the holding portion 2a of the sixth embodiment includes the two wall portions 2f and 2g. However, the holding portion 2a may include three or more wall portions.

Several embodiments of the present disclosure have been described, however, these embodiments are presented as examples and are not intended to limit the scope of the disclosure. These embodiments can be implemented in various other configurations, and various omissions, substitutions and changes can be made without departing from essential features of t disclosure. These embodiments and modifications thereof are included in the disclosure described in the scope of claims and the scope of their equivalents, as included in the essential features and the scope of the disclosure.

According to the present description, Aspects described below are provided.

### (Aspect 1)

A vehicular antenna device includes: a device portion that includes an antenna element; and a metal plate portion that holds the device portion. The metal plate portion is mounted to a metal part at the periphery of a hole or a cut-out formed in a metal roof of a vehicle, or mounted to a top surface of a roof lining of the vehicle. The device portion is positioned below a region in which the hole or the cut-out is positioned, when the metal plate portion is mounted.

According to Aspect 1, the device portion can be arranged above a region in which there is not such a member as to shield radio waves (region in which a hole or a cut-out is positioned). The metal plate portion is positioned between the vehicular electronic device and the device portion, and thus can also be used as a noise shielding plate that shields noise from the vehicular electronic device to the device portion, and a noise shielding plate that shields noise from the device portion to the vehicular electronic device.

Further, in the case where the metal plate portion is mounted to the metal part at the periphery of the hole or the cut-out, the vehicular antenna device is mounted to the metal part of the vehicle from below. Thus, as compared to a configuration in which the vehicular antenna device is mounted from above to the metal roof or embedded in a vehicle body, it is possible to reduce the burden on a worker by reducing the amount of work at places that are difficult to see.

Furthermore, when the metal plate portion is attached to the metal part at the periphery of the hole or the cut-out, the metal plate portion that functions as a ground plate can be easily formed larger as compared to a configuration in which the metal plate portion is mounted to other places. In particular, the metal plate portion can be extended to the length substantially equal to the width of the metal roof. Thus, it is possible to easily configure the antenna that needs a ground plate sufficiently larger than the antenna element, at a position lower than the metal roof.

Further, in the case where the metal plate portion is mounted to the top surface of the roof lining, the metal plate portion having a large area can be provided on the roof lining. In particular, the metal plate portion can be extended to the length substantially equal to the width of the metal roof, and furthermore, the metal plate portion can be extended in the longitudinal direction of the roof lining up to the length in the longitudinal direction of the roof lining. This makes it possible to use the metal plate portion having a larger area, as compared with a configuration in which the metal plate portion is mounted to the periphery of the hole or the cut-out in the metal roof. With the use of the metal plate portion having a large area, it is possible to obtain good antenna characteristics, and when multiple devices are arranged at the metal plate portion, it is possible to reduce each distance between the devices, thereby being able to reduce mutual electrical interference.

### (Aspect 2)

Preferably, the vehicular antenna device includes a lid portion above the device portion, the lid portion allowing radio waves to be transmitted therethrough. The region that is a top surface of the metal roof and is to contact the lid portion, and a top surface of the lid portion, are to be positioned on the same plane.

According to Aspect 2, the lid portion can protect the device portion that includes the antenna element, without causing the region in which the device portion 3 including the antenna element is positioned to stand out.

### (Aspect 3)

More preferably, the metal plate portion is mounted to the metal part at the periphery of the hole or the cut-out. The device portion includes a plurality of devices. The metal plate portion includes a plurality of plates. Each of the plurality of plates holds at least one of the plurality of devices.

According to Aspect 3, the mounting to the vehicle and removal therefrom can be performed for the multiple plates individually. This makes it possible to improve the workability of mounting and removal, as compared to a configuration in which the metal plate portion is formed of one single large plate. For example, if a malfunction occurs only in one device portion among multiple devices, the plate holding the corresponding device portion only needs to be removed to replace the corresponding device portion. In this case, the workability of removal and mounting can be improved as compared to a configuration in which the metal plate portion is formed of one single large plate.

### (Aspect 4)

Further, preferably, the metal plate portion is mounted to the roof lining. The metal plate portion is in the form of a thin plate or foil, the metal plate portion being configured to be electrically connected to a metal part of the vehicle.

According to Aspect 4, the metal plate portion is in the form of a thin plate or foil, thereby being able to reduce the weight of the parts mounted to the vehicle, as compared to a configuration in which the metal plate portion is made of a plate having a normal thickness.

### (Aspect 5)

Further, preferably, the device portion includes a first device and a second device, and the metal plate portion includes a conductive wall portion positioned between the first device and the second device.

According to Aspect 5, the wall portion is positioned between the two devices, thereby being able to use the wall portion as a noise shielding plate.

### (Aspect 6)

The vehicular antenna device includes: a device portion that includes an antenna element; and a metal plate portion that holds the device portion. The metal plate portion is mounted to an undersurface of a lid portion, and the lid portion allows radio waves to be transmitted therethrough and covers a hole or a cut-out formed in a metal roof of a vehicle.

According to Aspect 6, it is possible to easily mount and remove the metal plate portion and the like to and from the vehicle, as compared to a configuration in which the metal plate portion and the like are mounted to the metal roof or the like of the vehicle.

### (Aspect 7)

Also, preferably, the device portion includes a first device and a second device, and the metal plate portion includes a conductive wall portion positioned between the first device and the second device.

According to Aspect 7, the wall portion is positioned between the two devices, thereby being able to use the wall portion as a noise shielding plate.

### REFERENCE SIGNS LIST

1 vehicular antenna device
2 metal plate portion
21 first plate
22 second plate
23 third plate
24 fourth plate
2a Holding portion
2b1 first arm portion
2b2 second arm portion
2c1 first connecting portion
2c2 second connecting portion
2d metal spring
2e-2g wall portion
3 device portion
3a-3f first device-sixth device
4 cable
5 bracket
100 metal roof
101 opening
110 reinforcement
120 lid portion
200 roof lining
300 antenna element

1. A vehicular antenna device, comprising:
a device portion that includes an antenna element; and
a metal plate portion that holds the device portion,
wherein the metal plate portion is mounted to a metal part at a periphery of a hole or a cut-out formed in a metal roof of a vehicle, or mounted to a top surface of a roof lining of the vehicle, and
wherein the device portion is positioned below a region in which the hole or the cut-out is positioned, when the metal plate portion is mounted.

2. The vehicular antenna device according to claim 1, further comprising:
a lid portion above the device portion, the lid portion allowing radio waves to be transmitted therethrough, and
a region that is a top surface of the metal roof and is to contact the lid portion and a top surface of the lid portion are to be positioned on a same plane.

3. The vehicular antenna device according to claim 1, wherein
the metal plate portion is mounted to the metal part at the periphery of the hole or the cut-out,
the device portion includes a plurality of devices,
the metal plate portion includes a plurality of plates, and
each of the plurality of plates holds at least one of the plurality of devices.

4. The vehicular antenna device according to claim 1, wherein
the metal plate portion is mounted to the roof lining, and
the metal plate portion is in a form of a thin plate or foil, the metal plate portion being configured to be electrically connected to a metal part of the vehicle.

5. The vehicular antenna device according to claim 1, wherein
the device portion includes a first device and a second device, and
the metal plate portion includes a conductive wall portion positioned between the first device and the second device.

6. A vehicular antenna device, comprising:
a device portion that includes an antenna element; and
a metal plate portion that holds the device portion,
wherein the metal plate portion is mounted to an undersurface of a lid portion, and the lid portion allows radio waves to be transmitted therethrough and covers a hole or a cut-out formed in a metal roof of a vehicle.

7. The vehicular antenna device according to claim 6, wherein
the device portion includes a first device and a second device, and
the metal plate portion includes a conductive wall portion positioned between the first device and the second device.
